(19) United States
(12) Patent Application Publication
(10) Pub. No.: US 2014/0168995 A1
(43) Pub. Date: Jun. 19, 2014

(54) LENS AND LED LAMP HAVING THE SAME

(71) Applicants: Foxconn Technology Co., Ltd., New Taipei (TW); CHAMP TECH OPTICAL (FOSHAN) CORPORATION, Foshan (CN)

(72) Inventors: CHIN-CHUNG CHEN, Tu-Cheng (TW); SHAN-YUE WANG, Foshan (CN); RUN-TIAN LIU, Foshan (CN)

(73) Assignees: FOXCONN TECHNOLOGY CO., LTD., New Taipei (TW); CHAMP TECH OPTICAL (FOSHAN) CORPORATION, Foshan (CN)

(21) Appl. No.: 13/896,340

(22) Filed: May 17, 2013

(30) Foreign Application Priority Data
Dec. 17, 2012 (CN) 2012105473500

(51) Int. Cl. F21V 5/04; F21K 99/00

(52) U.S. Cl. CPC F21V 5/04; F21K 9/58
USPC 362/311.02; 362/335

(57) ABSTRACT

A light emitting diode (LED) lamp includes a base, LED chips mounted on base, and a lens covering the LED chips and engaging with the base. The lens includes an arc-shaped engaging portion, and an extending portion extending from a radial outer side of a top surface of the engaging portion with a radial inner side of the top surface of the engaging portion exposed. The engaging portion includes an outer side surface. A groove is defined in an underside of the engaging portion and receives the LED chips therein. The extending portion includes an inner light emitting surface extending upwardly and outwardly from the top surface of the engaging portion, an outer light emitting surface extending upwardly from a top edge of the outer side surface of the engaging portion, and a top light emitting surface interconnecting the outer light emitting surface and the inner light emitting surface.

### BACKGROUND

1. Technical Field

The disclosure relates to a light emitting diode (LED) lamp having an LED chip and a lens which can increase the intensity of light emitted from the LED lamp in lateral directions whereby the LED lamp has a wider range of illumination.

2. Description of Related Art

LEDs have many beneficial characteristics, including low electrical power consumption, low heat generation, long lifetime, small volume, good impact resistance, fast response and excellent stability. These characteristics have enabled LEDs to be widely used as a light source in electrical appliances and electronic devices.

A conventional LED generally generates a smooth round light field with a radiation angle of 120 degrees (i.e. ±60 degrees). The light emitted from the LED is mainly concentrated at a center thereof. The light at a periphery of the LED is relatively poor and typically cannot be used to illuminate. Therefore the LED cannot be used in a lamp which requires a wide illumination range, for example, an explosion-proof lamp (which may be fitted to a miner's safety helmet) or a gas station canopy lamp.

What is needed, therefore, is an improved LED lamp which overcomes the above described shortcomings.

### BRIEF DESCRIPTION OF THE DRAWINGS

FIG. 1 is a top view of an LED lamp according to an exemplary embodiment of the present disclosure.

FIG. 2 is an isometric view of one lens of the LED lamp of FIG. 1.

FIG. 3 is an inverted view of the lens of FIG. 2.

FIG. 4 is an enlarged, cross-sectional view of the lens of FIG. 2, taken along line IV-IV thereof.

FIG. 5 is similar to FIG. 4, but also showing an LED chip of the LED lamp inside the lens, and light paths of the LED lamp.

### DETAILED DESCRIPTION

An embodiment of an LED lamp in accordance with the present disclosure will now be described in detail below and with reference to the drawings.

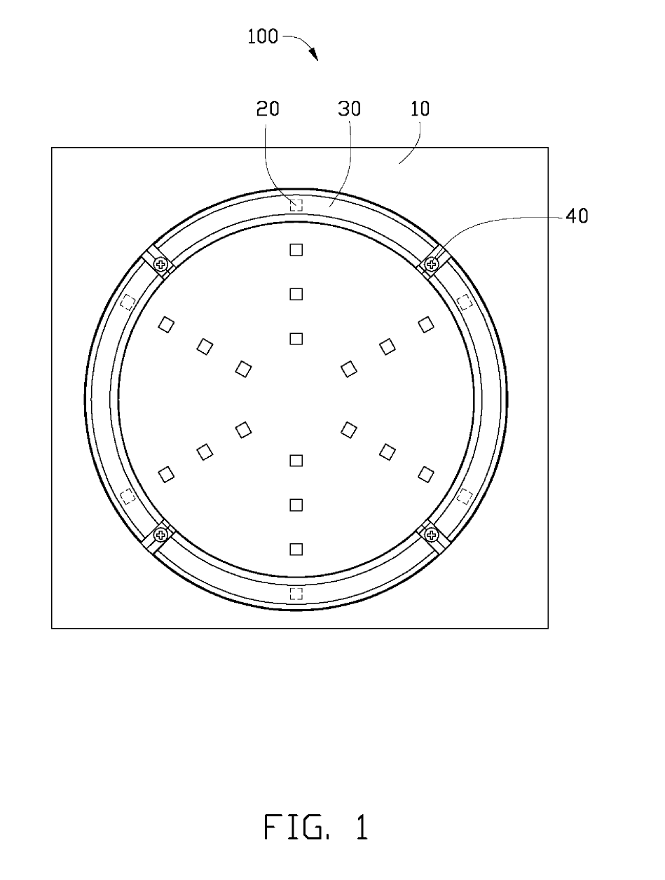

Referring to FIG. 1, an LED lamp 100 in accordance with an exemplary embodiment of the disclosure includes a base 10, a plurality of LED chips 20 mounted on the base 10, and a plurality of lenses 30 covering the LED chips 20 and engaging with the base 10.

The base 10 is electrically insulating and has good heat dissipation performance. A circuit is formed on a top surface of the base 10. The LED chips 20 are mounted on the top surface of the base 10, and electrically connect the circuit of the base 10. The LED chips 20 are spaced from each other, and are arranged on a plurality of concentric circles which are centered on a center of the base 10. In this embodiment, the LED chips 20 are arranged on four concentric circles. The number of LED chips 20 in each concentric circle is the same. The LED chips 20 in each concentric circle are equally angularly spaced from each other. Considered another way, the LED chips 20 are arranged in a plurality of rows, with each row radially extending in a direction from the center of the base 10 to a periphery of the base 10. The rows are equally angularly spaced from each other. In this embodiment, the LED chips 20 are arranged in six rows. Thus two of the rows are aligned with each other, another two of the rows are aligned with each other, and still another two of the rows are aligned with each other. The LED chips 20 in each row are evenly spaced from each other. The lenses 30 only cover the outmost concentric circle of the LED chips 20. Alternatively, the lenses 30 can cover all of the LED chips 20.

Each lens 30 is made of material with high light transmittance, for example, glass, PMMA (polymethylmethacrylate) or PC (polycarbonate). The lenses 30 cooperatively form a ring. In this embodiment, the ring is circular, and there are four lenses 30. Alternatively, an integrally formed circular lens can be provided. The circular lens is mounted on the base 10 to cover the LED chips 20.

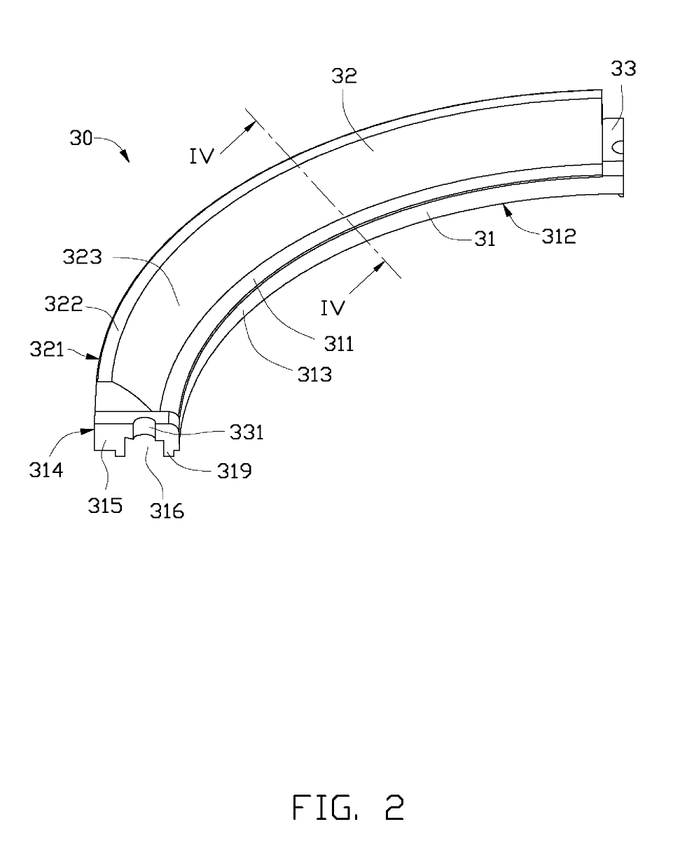

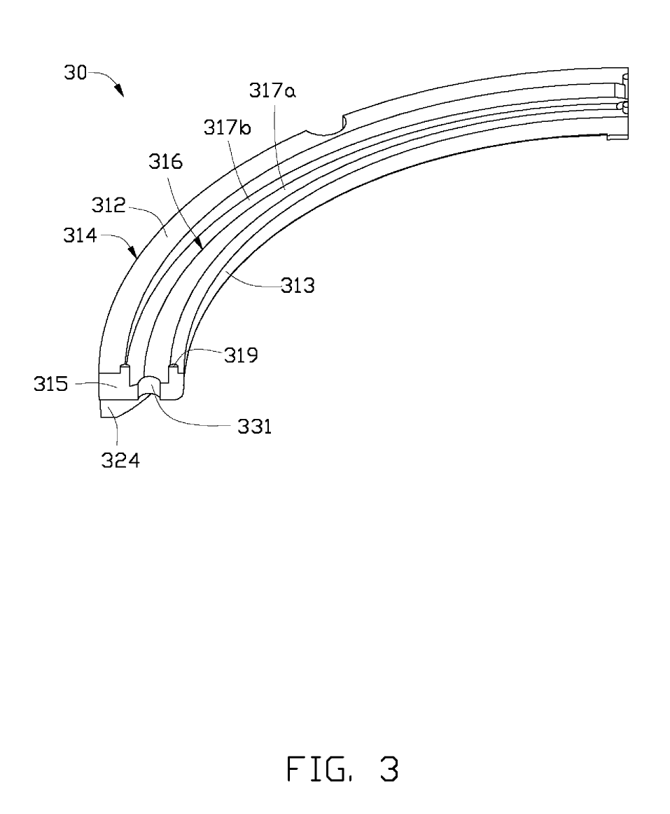

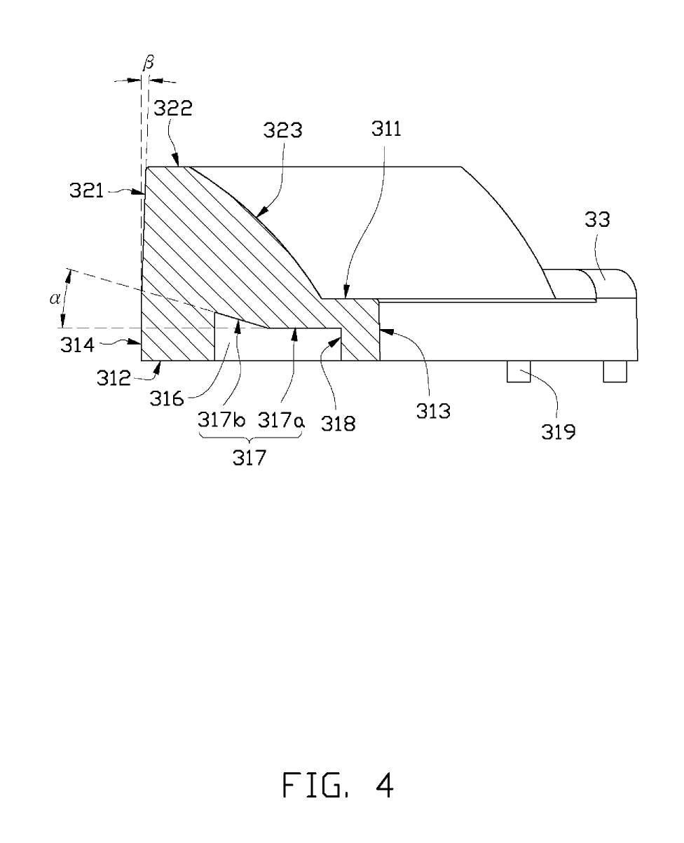

Referring also to FIGS. 2-4, each lens 30 includes an engaging portion 31 and an extending portion 32 extending up from a top side of the engaging portion 31. The engaging portion 31 and the extending portion 32 are integrally formed as a single monolithic body.

The engaging portion 31 is an arc-shaped plate. A transverse cross section of the engaging portion 31 is rectangular. The engaging portion 31 includes a top surface 311, a bottom surface 312, an inner side surface 313, an outer side surface 314, and two end surfaces 315. Each of the top surface 311 and the bottom surface 312 is an arc-shaped plane. The top surface 311 is parallel to the bottom surface 312. The outer side surface 314 is convex. The inner side surface 313 is concave. The inner side surface 313 is parallel to the outer side surface 314. Each of the inner side surface 313 and the outer side surface 314 is arc-shaped and subtends an angle of 90 degrees. Top and bottom edges of the outer side surface 314 and the inner side surface 313 connect lateral edges of the top surface 311 and the bottom surface 312. The end surfaces 315 are rectangular and interconnect corresponding edges of the bottom surface 312, the inner side surface 313 and the outer side surface 314 at each of opposite ends of the lens 30.

An arc-shaped groove 316 is defined in a central portion of the bottom surface 312 of the engaging portion 31, to receive either one or two of the LED chips 20 therein. The groove 316 extends through the engaging portion 31 along a longitudinal direction of the engaging portion 31. The groove 316 has an upper surface 317, and two lateral surfaces 318 extending downwardly from opposite lateral edges of the upper surface 317, respectively. The upper surface 317 acts as a light incident surface, and includes a first surface 317a and a second surface 317b. The first surface 317a is an arc-shaped plane, parallel to the bottom surface 312 and near the inner side surface 313. The second surface 317b extends upwardly and outwardly from an outer edge of the first surface 317a, and is obliquely angled with respect to the bottom surface 312. The second surface 317b is near the outer side surface 314. When the groove 316 is viewed in cross-section, an angle α is defined between a line coinciding with a profile of the first surface 317a and a profile of the second surface 317b. The angle α is in the range of from 15 degrees to 18 degrees. The lateral surfaces 318 extend downwardly from an inner edge of the first surface 317a and an outer edge of the second surface 317b, respectively. The lateral surfaces 318 are parallel to the inner side surface 313. Posts 319 extend downwardly from each of opposite ends of the bottom surface 312, to mount the lens 30 on the base 10.

The extending portion 32 extends upwardly from an outer part of the top surface 311 of the engaging portion 31. An inner part of the top surface 311 of the engaging portion 31 is bare (i.e. exposed). The extending portion 32 is an arc-shaped plate. A transverse cross section view of the extending portion 32 is approximately trapezoidal, with one of the nonparallel sides of the trapezium being gently curved. The extending portion 32 tapers from a bottom end connecting the engaging portion 31 to a top end away from the engaging portion 31. A transverse width of the bottom end of the extending portion 32 is less than that of the engaging portion 31. A length of the extending portion 32 is slightly less than that of the engaging portion 31.

The extending portion 32 includes an outer light emitting surface 321, a top light emitting surface 322, an inner light emitting surface 323, and two connecting surfaces 324. The outer light emitting surface 321 is convex and subtends an angle of slightly less than 90 degrees. The outer light emitting surface 321 extends upwardly and slightly inwardly from a top edge of the outer side surface 314, and thus can be considered to be oriented slightly towards the inner side surface 313. When the lens 30 is viewed in cross-section, an angle β is defined between a line coinciding with a profile of the outer side surface 314 and a profile of the outer light emitting surface 321. The angle β is in the range of from 1 degree to 3 degrees. The top light emitting surface 322 is an arc-shaped plane, and is parallel to the top surface 311 of the engaging portion 31.

The inner light emitting surface 323 extends upwardly and outwardly from a central portion of the top surface 311 to the top light emitting surface 322. Opposite longitudinal edges of the top light emitting surface 322 respectively connect top edges of the outer light emitting surface 321 and the inner light emitting surface 323. The inner light emitting surface 323 subtends an angle of slightly less than 90 degrees; and a transverse cross-section of the inner light emitting surface 323 is slightly convex. In one embodiment, a radius of the inner light emitting surface 323 varies between 18 mm (millimeters) at the inmost extremity thereof and 25 mm at the outmost extremity thereof. The inner light emitting surface 323 is located generally at an outer side of the inner lateral surface 318 of the groove 316, and thus is also located generally at an outer side of the inner side surface 313. A step is formed between the inner light emitting surface 323 and the inner part of the top surface 311. Opposite ends of the engaging portion 31 form two mounting portions 33, respectively. The mounting portions 33 are raised relative to the top surface 311. The posts 319 extend downwardly from the bottom surface 312 at the mounting portions 33. A vertical channel 331 is defined in a central part of each mounting portion 33 at the end surface 315. The channel 331 communicates with the groove 316.

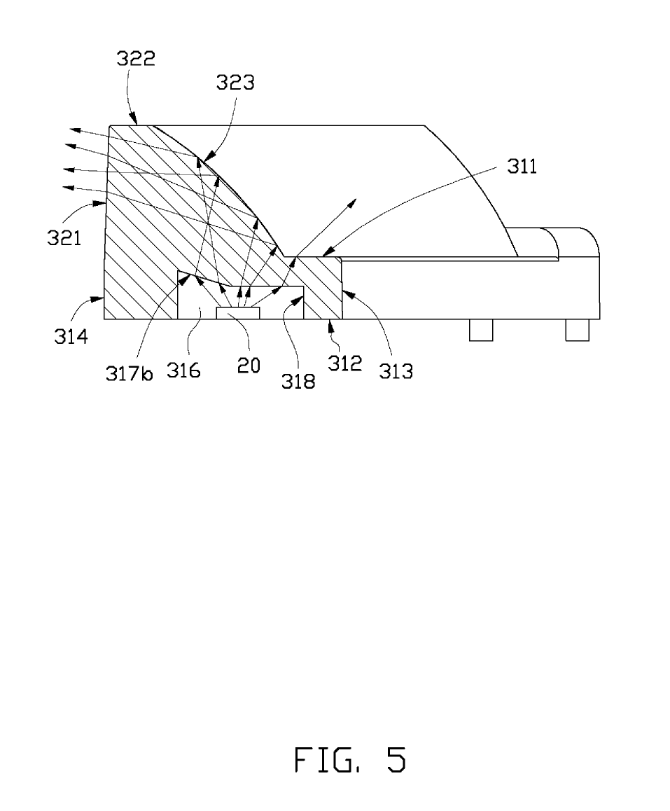

Referring to FIG. 1, when the LED lamp 100 is assembled, the lenses 30 are arranged on the top surface of the base 10 end to end to form the ring. Two adjacent mounting portions 33 of each two adjacent lenses 30 abut each other, and the channels 331 of the two mounting portions 33 cooperatively form a receiving space. A screw 40 extends through the receiving space and engages with the base 10 to mount the two lenses 30 on the base 10. The grooves 316 of the lenses 30 communicate with each other to collectively receive the outmost concentric circle of the LED chips 20 therein. Referring also to FIG. 5, each of the LED chips 20 is located at a center of a transverse dimension of the corresponding groove 316, and is spaced from the upper surface 317 and the lateral surfaces 318. In the illustrated embodiment, each LED chip 20 is located directly below a junction of the first and second surfaces 317a, 317b.

Referring to FIG. 5, during operation of the LED lamp 100, light emitted from the LED chips 20 travels into the lenses 30 via the upper surfaces 317 of the grooves 316. For each lens 30, a part of such incident light transmits directly to the inner part of the top surface 311 of the engaging portion 31, and to the outer light emitting surface 321 (light path not shown) and the top light emitting surface 322 (light path not shown) of the extending portion 32, and then directly exits the lens 30 to illuminate. Another part of the incident light transmits directly to the inner light emitting surface 323. Most of the light incident on the inner light emitting surface 323 is reflected by the inner light emitting surface 323 and transmits to the top light emitting surface 322 and the outer light emitting surface 321 to exit therefrom and illuminate. Some of the light incident on the inner light emitting surface 323 is refracted by the inner light emitting surface 323 (light path not shown) and exits the inner light emitting surface 323 to illuminate. Thus overall, the LED lamp 100 has a radiation angle of more than 120 degrees as measured from the center of the base 10.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A lens for adjusting light emitted from a light source that emits the light in upward directions whereby light intensity of the adjusted light at a lateral side of the light source is increased, the lens comprising:
an arc-shaped engaging portion comprising an outer side surface, a groove defined in an underside of the engaging portion, the groove configured to receive the light source therein; and
an arc-shaped extending portion extending up from a radial outer side of a top surface of the engaging portion with a radial inner side of the top surface of the engaging portion exposed, the extending portion comprising an inner light emitting surface extending upwardly and outwardly from the top surface of the engaging portion, an outer light emitting surface extending upwardly from a top edge of the outer side surface of the engaging portion, and a top light emitting surface interconnecting the outer light emitting surface and the inner light emitting surface;
wherein light emitted from the light source transmits into the lens via the groove, a part of the light directly transmits out of the lens from the exposed part of the top surface of the engaging portion, and from the outer light emitting surface and the top light emitting surface of the extending portion, and another part of the light is incident on the inner light emitting surface and reflected to the outer light emitting surface and the top light emitting surface and transmits out of the lens from the outer light emitting surface and the top light emitting surface.

2. The lens of claim 1, wherein the extending portion subtends an angle of less than 90 degrees at an imaginary center point of a circle, and a transverse cross-section of the inner light emitting surface is convex.

3. The lens of claim 2, wherein a radius of the inner light emitting surface varies between 18 millimeters (mm) at an inmost extremity of the inner light emitting surface and 25 mm at an outmost extremity of the inner light emitting surface.

4. The lens of claim 1, wherein the groove has an upper surface, and two lateral surfaces extending downwardly from opposite lateral edges of the upper surface, respectively, the upper surface acts as a light incident surface, and a bottom end of the inner light emitting surface is positioned generally between the lateral surfaces.

5. The lens of claim 4, wherein the upper surface comprises a first surface and a second surface, the first surface is an arc-shaped plane and near the inner side surface, the second surface extends upwardly and outwardly from an outer edge of the first surface and is obliquely angled with respect to the bottom surface, and the second surface is near the outer side surface.

6. The lens of claim 5, wherein an angle is defined between a line coinciding with a profile of the first surface and a line of a profile of the second surface, and the angle is in the range of from 15 degrees to 18 degrees.

7. The lens of claim 1, wherein the engaging portion further comprises a bottom surface parallel to the top surface, and an inner side surface, the inner side surface and the outer side surface connect opposite edges of the top surface and the bottom surface, and the groove is defined in the bottom surface.

8. The lens of claim 7, wherein each of the outer side surface and the outer light emitting surface is convex, the outer light emitting surface extends upwardly and inwardly from the top edge of the outer side surface, and an angle is defined between a line coinciding with a profile of the outer side surface and a line of a profile of the outer light emitting surface.

9. The lens of claim 8, wherein the angle is in the range of from 1 degree to 3 degrees.

10. The lens of claim 8, wherein the inner side surface and the outer side surface are parallel to each other.

11. The lens of claim 8, wherein a step is formed between the inner light emitting surface and the radial inner side of the top surface.

12. A light emitting diode (LED) lamp comprising:
a base;
one or more LED chips mounted on base; and
a lens covering the LED chips and engaging with the base, the lens comprising:
an arc-shaped engaging portion comprising an outer side surface, a groove defined in an underside of the engaging portion, the groove having the LED chips received therein; and
an arc-shaped extending portion extending from a radial outer side of a top surface of the engaging portion with a radial inner side of the top surface of the engaging portion exposed, the extending portion comprising an inner light emitting surface extending upwardly and outwardly from the top surface of the engaging portion, an outer light emitting surface extending upwardly from a top edge of the outer side surface of the engaging portion, and a top light emitting surface interconnecting the outer light emitting surface and the inner light emitting surface;
wherein light emitted from the LED chips transmits into the lens via the groove, a part of the light directly transmits out of the lens from the exposed part of the top surface of the engaging portion, and from the outer light emitting surface and the top light emitting surface of the extending portion, and another part of the light is incident on the inner light emitting surface and reflected to the outer light emitting surface and the top light emitting surface and transmits out of the lens from the outer light emitting surface and the top light emitting surface.

13. The LED lamp of claim 12, further comprising at least another lens, wherein the plurality of lenses is arranged on a top surface of the base end to end to form a ring.

14. The LED lamp of claim 13, wherein the LED chips are spaced from each other and arranged in a plurality of concentric circles.

15. The LED lamp of claim 14, wherein the lenses cover the LED chips of the outmost concentric circle.

16. The LED lamp of claim 14, wherein the LED chips are arranged in a plurality of rows, with each row radially extending in a direction from a center of the base to a periphery of the base.

17. The LED lamp of claim 13, wherein for each lens a length of the extending portion along the arc-shape is less than a length of the engaging portion along the arc-shape such that opposite ends of the engaging portion are exposed from the extending portion, a channel is defined in a surface of each exposed end, and two adjacent channels of each two adjacent lenses cooperatively define a receiving space to receive a screw therein.

18. The LED lamp of claim 17, wherein one or more posts protrude from each of the exposed ends of each lens and are engaged with the base.

19. The LED lamp of claim 12, wherein the inner light emitting surface subtends an angle of less than 90 degrees at an imaginary center point of a circle, and a transverse cross-section of the inner light emitting surface is convex.

20. The LED lamp of claim 19, wherein a radius of the inner light emitting surface varies between 18 millimeters (mm) at an inmost extremity of the inner light emitting surface and 25 mm at an outmost extremity of the inner light emitting surface.
